(19) United States
(12) Patent Application Publication
(10) Pub. No.: US 2022/0410207 A1
(43) Pub. Date: Dec. 29, 2022

(54) METHOD FOR FORMING PARTING LINE

(71) Applicant: TOYOTA JIDOSHA KABUSHIKI KAISHA, Toyota-shi (JP)

(72) Inventors: Yuki NAGANUMA, Nagoya-shi (JP); Shoji KATO, Toyota-shi (JP)

(73) Assignee: TOYOTA JIDOSHA KABUSHIKI KAISHA, Toyota-shi (JP)

(21) Appl. No.: 17/830,836

(22) Filed: Jun. 2, 2022

(30) Foreign Application Priority Data
Jun. 25, 2021 (JP) 2021-105673

(51) Int. Cl. B05D 1/32

(52) U.S. Cl. CPC B05D 1/325

(57) ABSTRACT

Provided is a method for forming a parting line when an easily peelable coating material is used as a coating material, The present disclosure is a method for forming a patting line in a coating using an easily peelable coating material. The method includes: (i) attaching a masking tape to a part not to be coated on a boundary between a part to be coated and the part not to be coated along the boundary, here, the masking tape including a lower masking tape constituent layer and an upper masking tape constituent layer; (ii) applying an easily peelable coating material over the part to be coated and a part in contact with the boundary of the masking tape; (iii) peeling off the upper masking tape constituent layer; hardening the easily peelable coating material; and (v) peeling off the lower masking tape constituent layer.

### CROSS REFERENCE TO RELATED APPLICATIONS

The present application claims priority from Japanese patent application JP 2021-105673 filed on Jun. 25, 2021, the entire content of which is hereby incorporated by reference into this application.

### BACKGROUND

### Technical Field

The present disclosure relates to a method for forming a parting line, specifically, a method for forming a parting line in a coating using an easily peelable coating material.

### Description of Related Art

For vehicles, such as an automobile, as a measure for improving the designability of exterior parts, such as a front panel and a pillar, for example, a partial black coating, a metallic two-tone color coating, and a stripe coating have been performed.

In forming such various designs, it is important for an excellent designability to form a boundary between a coated part and a non-coated part, or a boundary between different colored coating films, that is, a parting line to be sharp and clear.

For example, JP H04-94766 A discloses a coating method for a parting part in which when a plurality of different colors are separately coated on a coating surface of an object to be coated, a masking is attached to an already coated surface of the object to be coated to cover a necessary part, and a different color is separately coated on the other part excluding the covered part. In the coating method for a parting part, the masking includes an upper tape and a lower tape which are mutually attached. In one end portion of both tapes, a stepped portion is formed in a state where the lower tape is positioned inside with respect to the upper tape. In the separately coating, the stepped portion is positioned at the parting part, the lower tape side is attached to the already coated surface, and subsequently, a clear coating material is applied over a part excluding the masking. Next, only the upper tape is removed, and subsequently, a color base coating material is applied over a part excluding the lower tape to cover the end portion of the clear coating material with the color base coating material.

JP 2018-90730 A discloses a method for forming a coating film using a masking tape. The masking tape includes at least a substrate, a linear body, and an adhesive layer. The substrate includes a polymer film extending in a longitudinal direction of the masking tape. The linear body is disposed to be parallel to an end side as an end in a width direction of the masking tape. The method includes at least (1) to (5) below: (1) a step of covering a masking region using a masking tape, or covering the masking region with a masking sheet while securing an end portion of the masking sheet to an edge of the masking region using the masking tape, or covering the masking region with a masking sheet with a masking tape using the masking tape in which the masking sheet with the masking tape is preliminarily disposed; (2) a step of forming a first coating film in the region to be coated; (3) a step of removing an unnecessary coating film together with the substrate in contact with the linear body by pulling up the linear body from the masking tape to cut out the coating film immediately above the linear body, or removing an unnecessary coating film by pulling up the end side of the masking tape with respect to the linear body and the linear body itself to cut out the coating film immediately above the linear body and the coating film in the end side with respect to the linear body; (4) a step of forming an uppermost coating film in the region to be coated; and (5) a step of peeling off the masking tape or peeling off the masking tape and removing the masking sheet or the masking sheet with the masking tape.

### SUMMARY

Nowadays, for expressing the individuality, opportunities of creating various designs have increased. Especially, the use of the two-tone colored design in which various two colors are combined as a design has increased.

In the coating method using an ordinary coating material, a parting line is formed as follows. A masking tape is attached to a part not to be coated on a boundary between a part to be coated and the part not to be coated along the boundary (that is, so as to be in contact with the boundary), and a coating material is applied over the part to be coated and a part in contact with the boundary of the masking tape to make the boundary clear by sufficiently applying the coating material over the part to be coated, especially the part in contact with the boundary of the part to be coated, and the masking tape is peeled off after the coating material is hardened by drying and the like, thus forming the parting line.

FIG. 1 schematically illustrates an exemplary coating method using an ordinary coating material. In FIG. 1, first, in (1) masking step, a masking tape 2 is attached to a part not to be coated on a boundary between a part to be coated and the part not to be coated of a foundation layer 1 along the boundary, in (2) coating material applying step, a coating material 3 is applied over the part to be coated of the foundation layer 1 and a part in contact with the boundary of the masking tape 2 by spraying or the like, in (3) hardening step, the coating material 3 is hardened by drying or the like to form a coating film 4, and in (4) masking peeling off step, the masking tape 2 is peeled off thus completing the coating.

However, when the above-described coating method is applied to a case of using an easily peelable coating material, since the step of peeling off the masking tape is performed after hardening the coating material, the easily peelable coating material firmly adhered to the masking tape is also peeled off together with the masking tape. Therefore, it is difficult to form a clear parting line.

Accordingly, the present disclosure provides a method for forming a patting line when an easily peelable coating material is used as a coating material.

The inventors examined various means to solve the problem, and found the following. In a method for forming a parting line in a coating using an easily peelable coating material, the method including: a step of attaching a masking tape on a part not to be coated on a boundary between a part to be coated and the part not to be coated along the boundary (that is, so as to be in contact with the boundary); a step of applying the easily peelable coating material over the part to be coated and a part in contact with the boundary of the masking tape by sufficiently applying the coating material over the part to be coated, especially, a part in contact with the boundary of the part to be coated to make the boundary clear and then to clearly form a parting design; a step of hardening the easily peelable coating material; and a step of peeling off the masking tape, a masking tape including a lower masking tape constituent layer and an upper masking tape constituent layer is used as the masking tape, the upper masking tape constituent layer is peeled off after applying the easily peelable coating material, subsequently, the easily peelable coating material is hardened, and next, the lower masking tape constituent layer is peeled off, thereby allowing avoiding adherence of the easily peelable coating material to the masking tape to avoid peeling off of the easily peelable coating material together when the masking tape is peeled off. Thus, the inventors achieved the present disclosure.

That is, the gist of the present disclosure is as follows.

(1) The present disclosure is a method for forming a parting line in a coating using an easily-peelable coating material. The method comprises:

(i) attaching a masking tape to a part not to be coated on a boundary between a part to be coated and the part not to be coated along the boundary, the masking tape including a lower masking tape constituent layer and an upper masking tape constituent layer;

(ii) applying an easily peelable coating material over the part to be coated and a part in contact with the boundary of the masking tape;

(iii) peeling off the upper masking tape constituent layer;

(iv) hardening the easily peelable coating material; and

(v) peeling off the lower masking tape constituent layer.

(2) In the method according to (1), in the (i), the lower masking tape constituent layer has, for example, a pencil hardness of HB or more.
(3) In the method according to (2), the lower masking tape constituent layer is, for example, a plastic masking tape.
(4) In the method according to any one of (1) to (3), the (ii) further includes (ii') half-hardening the easily peelable coating material.
(5) In the method according to any one of (1) to (4), the easily peelable coating material contains a volatile solvent, the (ii) further includes (ii') flashing-off and the (iv) is hardening by drying.
(6) In the method according to (5), in the (ii') flashing-off, a temperature is from 20° C. to 100° C., and a flash-off time is from 30 seconds to 10 minutes.

The present disclosure provides the method for forming the parting line when the easily peelable coating material is used as the coating material.

### BRIEF DESCRIPTION OF THE DRAWINGS

FIG. 1 is a drawing schematically illustrating an exemplary coating method using an ordinary coating material;

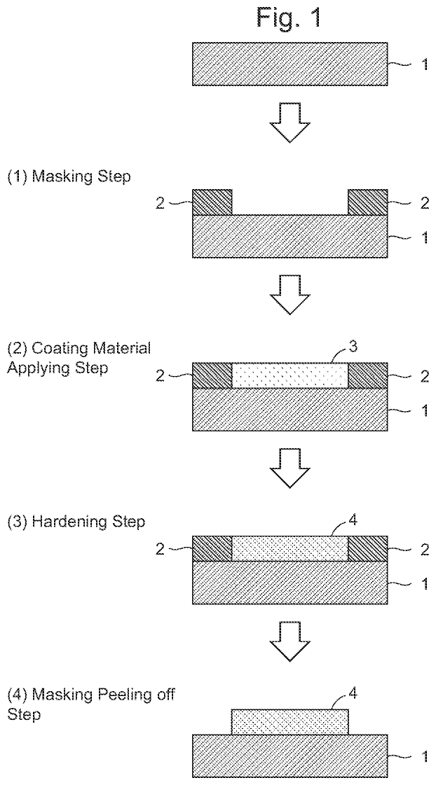

FIG. 2 is a drawing schematically illustrating an example of a method for forming a parting line in a coating using an easily peelable coating material according to the disclosure; and

FIG. 3 is a drawing schematically illustrating an example of the method for forming a parting line in a coating using an easily peelable coating material according to the disclosure.

### DETAILED DESCRIPTION OF THE EMBODIMENTS

The following describes embodiments of the present disclosure in detail.

In the description, features of the present disclosure will be described with reference to the drawings as necessary. In the drawings, dimensions and shapes of respective components are exaggerated for clarification, and actual dimensions or shapes are not accurately illustrated. Accordingly, the technical scope of the present disclosure is not limited to the dimensions and the shapes of respective components illustrated in the drawings. Note that, a method for forming a parting line of the present disclosure is not limited to the embodiments below, and can be performed in various configurations where changes, improvements, and the like which a person skilled in the art can make are given without departing from the gist of the present disclosure.

The present disclosure relates to a method for forming a parting line in a coating using an easily peelable coating material, the method including (i) attaching a masking tape to a part not to be coated on a boundary between a part to be coated and the part not to be coated along the boundary, the masking tape including a lower masking tape constituent layer and an upper masking tape constituent layer, (ii) applying an easily peelable coating material over the part to be coated and a part in contact with the boundary of the masking tape, (iii) peeling off the upper masking tape constituent layer, (iv) hardening the easily peelable coating material, and (v) peeling off the lower masking tape constituent layer.

In the present disclosure, the steps (i) to (v) are basically performed in the order from (i) to (v). The following describes each of the steps (i) to (v).

(i) Step of Attaching Masking Tape to Part Not to Be Coated on Boundary between Part to Be Coated and Part Not to Be Coated along Boundary, Masking Tape Including Lower Masking Tape Constituent Layer and Upper Masking Tape Constituent Layer (Masking Step)

In the step (i), the masking tape is attached to the part not to be coated on the boundary between the part to be coated and the part not to be coated along the boundary, that is, so as to be in contact with the boundary, and the masking tape includes the lower masking tape constituent layer and the upper masking tape constituent layer.

The boundary between the part to be coated and the part not to be coated is a part at which the parting line is formed, and also referred to as a parting part.

The masking tape is a tape attached to a foundation layer to mask the part not to be coated, and peeled off after coating with the easily peelable coating material. Accordingly, the masking tape has an adhesive strength finally peelable from the foundation layer.

The masking tape includes the lower masking tape constituent layer and the upper masking tape constituent layer. The masking tape may include an intermediate masking tape constituent layer including one or more layers in addition to the lower masking tape constituent layer and the upper masking tape constituent layer. The masking tape may be configured, for example, such that the lower masking tape constituent layer is attached to the foundation layer, and after that, the upper masking tape constituent layer is attached to the lower masking tape constituent layer, or may be configured such that the masking tape including the two masking tape constituent layers produced by preliminarily laminating the lower masking tape constituent layer and the upper masking tape constituent layer is attached to the foundation layer.

The masking tape has a configuration in which the lower masking tape constituent layer and the upper masking tape constituent layer are peelable from each other. That is, in the masking tape, the lower masking tape constituent layer and the upper masking tape constituent layer are adhered with a peelable adhesive strength. An adhesive having such an adhesive strength is publicly known in the technical field, and not limited.

Since the masking tape has the configuration in which the upper masking tape constituent layer is peelable from the lower masking tape constituent layer (or the lower masking tape constituent layer is peelable from the upper masking tape constituent layer), the upper masking tape constituent layer of the masking tape to which the easily peelable coating material is attached in the step (ii) can be peeled off while the lower masking tape constituent layer in the step (iii) described below.

In the parting part, all of the masking tape constituent layers constituting the masking tape are stacked without deviation along the parting part in some embodiments.

Since all of the masking tape constituent layers of the masking tape are stacked without deviation in the parting part, the easily peelable coating material can be uniformly applied along the parting part in the step (ii) described below, and a part in contact with the parting part of the masking tape to which the easily peelable coating material is attached in the step (ii) can be removed by peeling off the upper masking tape constituent layer constituting the masking tape in the step (iii) described below.

The lower masking tape constituent layer directly in contact with the foundation layer in the masking tape includes a masking tape known in the technical field, and is not limited. The lower masking tape constituent layer is a hard layer in some embodiments. The lower masking tape constituent layer may have a hardness equal to or more than a pencil hardness of HB (based on Japanese Industrial Standard (JIS) K5600 Testing methods for paints—Part 5, Section 4: Scratch hardness (Pencil method)). The lower masking tape constituent layer having such a hardness includes a masking tape made of a material known in the technical field, and is not limited. For example, a plastic masking tape, such as an acrylic masking tape is included.

With the masking tape in which the lower masking tape constituent layer directly in contact with the foundation layer is a hard layer, the more distinct, sharp, and clear parting line can be formed in the step (v) described below.

The thickness of the lower masking tape constituent layer is not limited. The thickness of the lower masking tape constituent layer is usually from 10 μm to 200 μm, and may be from 50 μm to 150 μm. The thickness of the lower masking tape constituent layer may be thick or thin compared with the thickness of the coating film of the easily peelable coating material.

As described above, since the masking tape is finally peeled off from the foundation layer, the foundation layer and the lower masking tape constituent layer directly in contact with the foundation layer are adhered to each other with a peelable adhesive strength. The adhesive having such an adhesive strength is publicly known in the technical field, and not limited. To peel off the upper masking tape constituent layer while leaving the lower masking tape constituent layer in the step (iii) described below, the adhesive strength between the foundation layer and the lower masking tape constituent layer directly in contact with the foundation layer is equal to or more than the adhesive strength between the upper masking tape constituent layer and the lower masking tape constituent layer directly in contact with the upper masking tape constituent layer in some embodiments.

The upper masking tape constituent layer disposed on the lower masking tape constituent layer in the masking tape includes a masking tape known in the technical field, and is not limited. The upper masking tape constituent layer may be a masking tape the same as the lower masking tape constituent layer, or may be a masking tape more flexible than the lower masking tape constituent layer, for example, having a pencil hardness of less than HB, such as a pencil hardness of 2B (based on Japanese Industrial Standard (JIS) K5600 Testing methods for paints—Part 5, Section 4: Scratch hardness (Pencil method)). The upper masking tape constituent layer may be a paper masking tape.

The thickness of the upper masking tape constituent layer is not limited. The thickness of the upper masking tape constituent layer is usually from 10 μm to 200 μm, and may be from 30 μm to 60 μm.

The intermediate masking tape constituent layer disposed between the lower masking tape constituent layer and the upper masking tape constituent layer in the masking tape in some cases includes a masking tape known in the technical field, and is not limited. Since the intermediate masking tape constituent layer has a role similar to that of the upper masking tape constituent layer, the intermediate masking tape constituent layer may be a masking tape the same as the upper masking tape constituent layer. When the intermediate masking tape constituent layer is disposed, the thickness of the intermediate masking tape constituent layer is not limited. The thickness of the intermediate masking tape constituent layer is usually from 10 μm to 200 μm, and may be from 30 μm to 60 μm.

The thickness of the masking tape, that is, the total thickness of the lower masking tape constituent layer and the upper masking tape constituent layer is usually from 20 μm to 400 μm, and may be from 80 μm to 210 μm. The thickness of the masking tape may be thick compared with the thickness of the coating film of the easily peelable coating material.

(ii) Step of Applying Easily Peelable Coating Material over Part to Be Coated and Part in Contact with Boundary of Masking Tape (Easily Peelable Coating Material Applying Step)

In the step (ii), the easily peelable coating material is applied over the part to be coated and the part in contact with the boundary of the masking tape.

The easily peelable coating material includes a coating material known in the technical field, and is not limited. The easily peelable coating material includes, for example, a coating material selected from the group consisting of coating material containing volatile solvents. Examples of the easily peelable coating material include a coating material containing an organic solvent, for example, xylene, ethylbenzene, and/or methyl ethyl ketone, an antioxidant, a silica reactant, a pigment, for example, titanium oxide (nanoparticles), and/or the like.

A method fbr applying the easily peelable coating material includes an applying method known in the technical field, and is not limited. Examples of the applying method include a manual application using a brush, a roller brush, a spatula, or the like, an application by equipment operation using an air spray, an airless spray, immersion, or the like, an application by device operation using adsorption by electrical attraction (electrostatic action).

In the step (ii), the easily peelable coating material is applied by a method with which the easily peelable coating material is uniformly and sufficiently applied over the part to be coated, especially, a part in contact with the parting part of the part to be coated in some embodiments.

The thickness of applying the easily peelable coating material is not limited The easily peelable coating material is applied such that the thickness of the coating film after hardening the easily peelable coating material is usually from 20 μm to 150 μm, and from 40 to 80 μm in some embodiments.

By applying the easily peelable coating material in the step (ii), the easily peelable coating material is applied over the part to be coated and a part of the masking tape attached in the step (i), especially the part in contact with the parting part of the masking tape.

The step (ii) may further include a step (ii') of half-hardening the easily peelable coating material to decrease the fluidity (to increase the viscosity) of the easily peelable coating material.

The step of half-hardening the easily peelable coating material, that is, the step (ii') can differ depending on the property of the easily peelable coating material.

For example, when the easily peelable coating material contains a volatile solvent, for example, xylene, ethylhenzene, acetone, methyl ethyl ketone, or a mixed solvent of them, and the like, the step (ii') can include a step of flashing-off (simply, a step of “flashing” in other words) to volatilize the solvents. While the step of flashing-off is not limited, the step of flashing-off can be performed in the atmosphere at usually from 15° C. to 100° C., from 20° C. to 100° C. in some embodiments, from 15° C. to 60° C. in some embodiments, and from 20° C. to 50° C. in some embodiments. While a flash--off time in the step of flashing-off can depend on the temperature in the step of flashing-off, the flash-off time may be set to be shorter, usually 30 minutes or less, 10 minutes or less in some embodiments, and three minutes or less in some embodiments. Since the excessively short flash-off time fails to half-harden the easily peelable coating material, the flash-off time is usually 30 seconds or more, and one minute or more in some embodiments.

For example, the step (ii') can include a heat treatment step when the easily peelable coating material contains a thermosetting resin. The heat treatment step is performed for a period at a temperature enough to half-harden the easily peelable coating material without completely hardening it.

For example, the step (ii') can include a light irradiation step when the easily peelable coating material contains a photocurable resin. The irradiation step is performed with a light wavelength for a period enough to half-harden the easily peelable coating material without completely hardening it.

Since the step (ii) further includes the step (ii'), the fluidity of the easily peelable coating material is decreased (the viscosity is increased), and dropping of the easily peelable coating material on the newly formed lower or intermediate masking tape constituent layer can be avoided even when the upper masking tape constituent layer is peeled off in the step (iii) described below.

(iii) Step of Peeling off Upper Masking Tape Constituent Layer (Upper Masking Tape Constituent Layer Peeling off Step)

In the step (iii), the upper masking tape constituent layer is peeled off.

By peeling off the upper masking tape constituent layer, only the upper masking tape constituent layer of the masking tape to which the easily peelable coating material is attached in the step (ii) can be removed. By removing the easily peelable coating material attached to the masking tape, especially, the surface of the upper masking tape constituent layer, adherence of the easily peelable coating material to the masking tape, that is, the lower masking tape constituent layer can be avoided in the step (iv) described below. Additionally, when the lower masking tape constituent layer is peeled off in the step (v) described below, peeling off the easily peelable coating material formed into the coating film together can be avoided.

(iv) Step of Hardening Easily Peelable Coating Material (Easily Peelable Coating Material Hardening Step)

In the step (iv), the easily peelable coating material is hardened.

The hardening of the easily peelable coating material can differ depending on the property of the used easily peelable coating material.

For example, when the easily peelable coating material contains a volatile solvent, and is formed into the coating film by the volatilization of the volatile solvent, a drying step fir volatilizing the solvent can be included. While the drying step is not limited, the drying step can be performed in the atmosphere at usually from 15° C. to 100° C., from 15° C. to 80° C. in some embodiments, and from 40° C. to 60° C. in some embodiments for usually from one minute to 30 minutes, and from three minutes to 10 minutes in some embodiments.

For example, when the easily peelable coating material contains a thermosetting resin, and is formed into the coating film by hardening the thermosetting resin, a heat treatment step can be included. The heat treatment step is performed for a period at a temperature enough to completely form the easily peelable coating material into the coating film.

For example, when the easily peelable coating material contains a photocurable resin, and is formed into the coating film by hardening the photocurable resin, a light irradiation step can be included. The irradiation step is performed with a light wavelength for a period enough to completely form the easily peelable coating material into the coating film.

By the step (iv), the easily peelable coating material can be formed into the coating film.

(v) Step of Peeling off Lower Masking Tape Constituent Layer (Lower Masking Tape Constituent Layer Peeling off Step)

In the step (v), the lower masking tape constituent layer is peeled off.

Since only the upper masking tape constituent layer of the masking tape to which the easily peelable coating material has attached in the step (ii) is preliminarily removed in the step (iii), the adherence of the easily peelable coating material to the masking tape, that is, the lower masking tape constituent layer is avoided in the step (iv). Consequently, in the step (v), peeling off the easily peelable coating material formed into the coating film together by peeling off the lower masking tape constituent layer is avoided, thus allowing the formation of the distinct, sharp, and clear parting line.

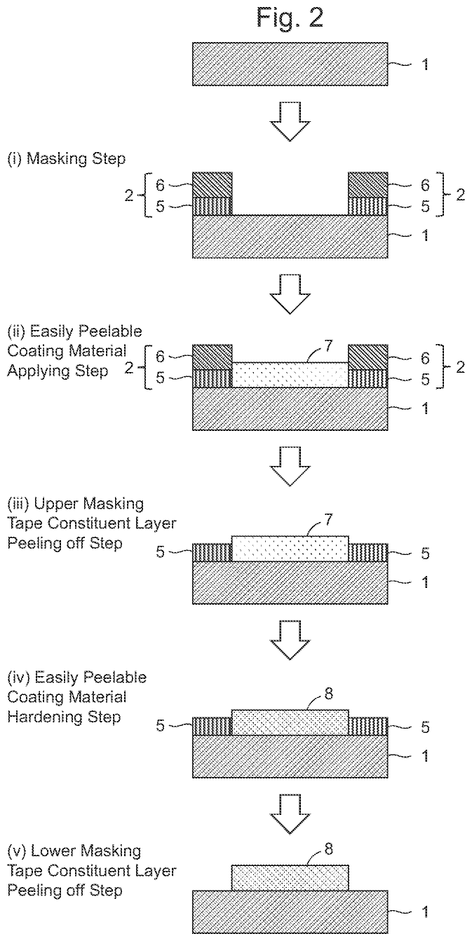

FIG. 2. schematically illustrates an example of the method for forming the parting line in the coating using the easily peelable coating material according to the disclosure. In FIG. 2, first, in the (i) masking step, the masking tape 2 including two layers of masking tape constituent layers 5 and 6 is attached to the part not to be coated on the boundary between the part to be coated and the part not to be coated of the foundation layer 1 along the boundary. In the (ii) easily peelable coating material applying step, an easily peelable coating material 7 is applied over the part to be coated of the foundation layer 1 and the part in contact with the boundary of the masking tape 2, especially, the upper masking tape constituent layer 6 by spraying or the like, and further, the easily peelable coating material 7 is half-hardened in some cases. In the (iii) upper masking tape constituent layer peeling off step, the upper masking tape constituent layer 6 to which the easily peelable coating material 7 before hardened has attached is peeled off. In the (iv) easily peelable coating material hardening step, the easily peelable coating material 7 is hardened by drying or the like to form a coating film 8 of the easily peelable coating material. In the (v) lower masking tape constituent layer peeling off step, the lower masking tape constituent layer 5 is peeled off, thus completing the coating. Consequently, the distinct, sharp, and clear parting line is formed.

In the method for forming the parting line in the coating using the easily peelable coating material according to the disclosure, when the masking tape includes the intermediate masking tape constituent layer, for example, after peeling off the upper masking tape constituent layer in the step (iii), the step (ii) is performed again to a part to be coated that is in contact with the masking tape and has not been coated yet, and subsequently, the intermediate masking tape constituent layer is peeled of thereby allowing performing two different coating with the masking tape as a boundary part.

In this case, the method for forming the parting line in the coating using the easily peelable coating material according to the disclosure includes:

(i) attaching a masking tape to a part not to be coated on a boundary between a part to be coated and the part not to be coated along the boundary, the masking tape including a lower masking tape constituent layer, an intermediate masking tape constituent layer, and an upper masking tape constituent layer;
(ii-1) applying an easily peelable coating material over a part of the part to be coated and a part in contact with the part of the part to be coated of the masking tape;
(iii-1) peeling off the upper masking tape constituent layer;
(ii-2) applying an easily peelable coating material over a part over which the easily peelable coating material has not been applied yet in (ii-1) and a part in contact with the part over which the easily peelable coating material has not been applied yet of the masking tape (lower masking tape constituent layer+intermediate masking tape constituent layer);
(iii-2) peeling off the intermediate masking tape constituent layer;
(iv) hardening the easily peelable coating materials; and
(v) peeling off the lower masking tape constituent layer.

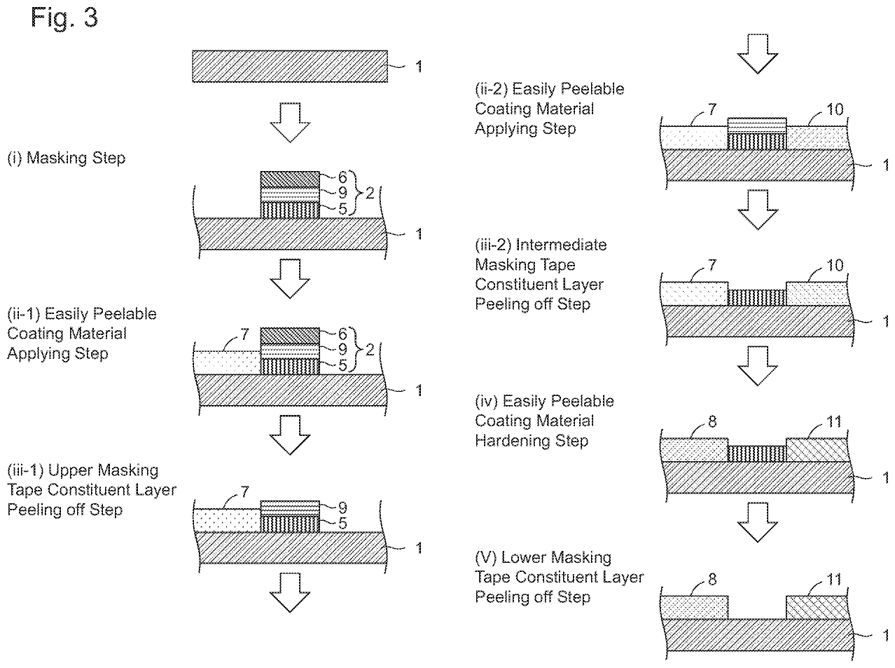

FIG. 3 schematically illustrates another example of the method for forming the parting line in the coating using the easily peelable coating material according to the disclosure. In FIG. 3, first, in the (i) masking step, the masking tape 2 including three layers of masking tape constituent layers 5, 9, and 6 is attached to the part not to be coated on the boundary between the part to be coated and the part not to be coated of the foundation layer 1 along the boundary. In the (ii-1) easily peelable coating material applying step, an easily peelable coating material 7 is applied over a part of the part to be coated of the foundation layer 1 and the part in contact with the boundary of the masking tape 2, especially, the upper masking tape constituent layer 6 by spraying or the like, and further, the easily peelable coating material 7 is half-hardened. in some cases. In the (iii-1) upper masking tape constituent layer peeling off step, the upper masking tape constituent layer 6 to which the easily peelable coating material 7 before hardened has attached is peeled off In the (ii-2) second easily peelable coating material applying step, another easily peelable coating material 10 is applied over a part over which the coating material has not been applied yet in the part to be coated of the foundation layer 1 and a part in contact with the boundary of the intermediate masking tape constituent layer 9 by spraying or the like, and further, the other easily peelable coating material 10 is half-hardened in some cases. In the (iii-2) intermediate masking tape constituent layer peeling off step, the intermediate masking tape constituent layer 9 to which the other easily peelable coating material 10 before hardened has attached is peeled off In the (iv) easily peelable coating material hardening step, the easily peelable coating material 7 and the other easily peelable coating material 10 are hardened by drying or the like to form a coating film 8 of the easily peelable coating material and a coating film 11 of the other easily peelable coating material. In the (v) lower masking tape constituent layer peeling off step, the lower masking tape constituent layer 5 is peeled off, thus completing the stripe coating in three colors. Consequently, the distinct, sharp, and clear parting line is formed.

With the above-described steps in the case where the masking tape includes the intermediate masking tape constituent layer, for example, the stripe coating in three colors separated by the masking tape can be easily performed.

### EXAMPLES

While the following describes some examples relating to the present disclosure, it is not intended to limit the present disclosure to the examples.

### 1. Examination of Lower Masking Tape Constituent Layer and Upper Masking Tape Constituent Layer

Based on the steps (i) to (v) below, the parting line was formed in the coating using the easily peelable coating material.

### Example 1

### (i) Masking Step

First, the lower masking tape constituent layer was attached to the part not to be coated on the boundary between the part to be coated and the part not to be coated along the boundary. Subsequently, the upper masking tape constituent layer was attached to the lower masking tape constituent layer so as to overlap the lower masking tape constituent layer.

For each of the lower masking tape constituent layer and the upper masking tape constituent layer, a masking tape having a pencil hardness of HB (based on Japanese Industrial Standard (JIS) K5600 Testing methods for paints—Part 5, Section 4: Scratch hardness (Pencil method)) was used.

### (ii) Easily Peelable Coating Material Applying Step

The easily peelable coating material was applied over the part to be coated and the part in contact with the parting part of the masking tape by spraying. As the easily peelable coating material, a commercially available coating material having a peelable property (coating material containing volatile solvent) was used. After applying the easily peelable coating material, the sample was left at 60° C. for 10 minutes as the flashing-off step.

### (iii) Upper Masking Tape Constituent Layer Peeling off Step

The upper masking tape constituent layer to which the easily peelable coating material was attached in the step (ii) was peeled off.

### (iv) Easily Peelable Coating Material Hardening Step

The heat treatment was performed at 60° C. for 20 minutes to harden the easily peelable coating material applied in the step (ii).

### (v) Lower Masking Tape Constituent Layer Peeling off Step

After hardening the easily peelable coating material in the step (iv), the lower masking tape constituent layer was peeled off, thus forming the parting line.

### Example 2

The parting line was formed similarly to the method of Example 1 except that a masking tape having a pencil hardness of 2B (based on Japanese Industrial Standard (JIS) K5600 Testing methods for paints—Part 5, Section 4: Scratch hardness (Pencil method)) was used for the lower masking tape constituent layer, and a masking tape having a pencil hardness of HB was used for the upper masking tape constituent layer in the (i) masking step of Example 1.

### Example 3

The parting line was formed similarly to the method of Example 1 except that a masking tape having a pencil hardness of HB was used for the lower masking tape constituent layer, and a masking tape haying a pencil hardness of 2B was used for the upper masking tape constituent layer in the (i) masking step of Example 1.

### Example 4

The parting line was formed similarly to the method of Example 1 except that a masking tape haying a pencil hardness of 2B was used for each of the lower masking tape constituent layer and the upper masking tape constituent layer in the (i) masking step of Example 1.

Table 1 illustrates the result.

TABLE 1

| | Example 1 | Example 2 | Example 3 | Example 4 |
|---|---|---|---|---|
| Upper Masking Tape | Pencil Hardness of | Pencil Hardness of | Pencil Hardness of | Pencil Hardness of |
| Constituent Layer | HB | HB | 2B | 2B |
| Lower Masking Tape | Pencil Hardness of | Pencil Hardness of | Pencil Hardness of | Pencil Hardness of |
| Constituent Layer | HB | 2B | HB | 2B |
| Result | Excellent | Good | Excellent | Good |

In Table 1, “Good” means that a clear parting line was formed, and “Excellent” means that a sharp and clear parting line was formed compared with “Good.” It was seen from Table 1 that for the lower masking tape constituent layer, a hard masking tape, especially, having the pencil hardness of HB or more, for example, a plastic masking tape, was appropriate.

2. Examination of (ii') Easily Peelable Coating Material Half-Hardening Step in Easily Peelable Coating Material Applying Step (Examination of Peeling off Timing of Upper Masking Tape Constituent Layer)

In the (ii) easily peelable coating material applying step of Example 3, the (iii) upper masking tape constituent layer peeling off step was performed () immediately after the application of the easily peelable coating material, and after the elapse of (2) flash-off time three minutes (23° C.), (3) flash-off time five minutes (23° C.), (4) 60° C. x three minutes, (5) 80° C. x three minutes, and (6) 100° C. x three minutes from the application of the easily peelable coating material.

Table 2 illustrates the result.

TABLE 2

| | 1 | 2 | 3 | 4 | 5 | 6 |
|---|---|---|---|---|---|---|
| Peeling off | immediately | Flash-off | Flash-off | 60° C. | 80° C. | 100° C. |
| Timing | After | 3 Minutes | 5 Minutes | 3 Minutes | 3 Minutes | 3 Minutes |
| Result | Poor | Excellent | Good | Good | Good | Good |

In Table 2, “Poor” means that the easily peelable coating material was dropped a little, “Good” means that the upper masking tape constituent layer was able to be peeled off without dropping of the easily peelable coating material, and “Excellent” means that the upper masking tape constituent layer was able to be peeled off without dropping of the easily peelable coating material in a shorter time than “Good.” It was seen from Table 2 that the easily peelable coating material half-hardening step was appropriately performed with the flash-off time at 23° C. to 100° C. for 30 seconds to 10 minutes, especially, at 23° C. for three minutes.

All publications, patents and patent applications cited in the present description are herein incorporated by reference as they are.

What is claimed is:

1. A method for forming a parting line in a coating using an easily peelable coating material, the method comprising:
(i) attaching a masking tape to a part not to be coated on a boundary between a part to be coated and the part not to be coated along the boundary, the masking tape including a lower masking tape constituent layer and an upper masking tape constituent layer;
(ii) applying an easily peelable coating material over the part to be coated and a part in contact with the boundary of the masking tape;
(iii) peeling off the upper masking tape constituent layer;
(iv) hardening the easily peelable coating material; and
(v) peeling off the lower masking tape constituent layer.

2. The method according to claim 1,
wherein in the (i), the lower masking tape constituent layer has a pencil hardness of HB or more.

3. The method according to claim 2,
wherein the lower masking tape constituent layer is a plastic masking tape.

4. The method according to claim 1,
wherein the (ii) further includes (ii') half-hardening the easily peelable coating material.

5. The method according to claim 1,
wherein the easily peelable coating material contains a volatile solvent, the (ii) further includes (ii') flashing-off, and the (iv) is hardening by drying.

6. The method according to claim 5,
wherein in the (ii') flashing-off a temperature is from 20° C. to 100° C., and a flash-off time is from 30 seconds to 10 minutes.
